(19) United States
(12) Patent Application Publication
(10) Pub. No.: US 2013/0188047 A1
(43) Pub. Date: Jul. 25, 2013

(54) TRAIL CAMERA

(71) Applicants: Richard S. Slevin, Los Altos Hills, CA (US); Margarita Kovats Slevin, Los Altos Hills, CA (US)

(72) Inventors: Richard S. Slevin, Los Altos Hills, CA (US); Margarita Kovats Slevin, Los Altos Hills, CA (US)

(21) Appl. No.: 13/744,393

(22) Filed: Jan. 17, 2013

Related U.S. Application Data
(60) Provisional application No. 61/587,628, filed on Jan. 17, 2012.

(51) Int. Cl. H04N 7/18

(52) U.S. Cl. CPC H04N 7/183
USPC 348/143

(57) ABSTRACT

A system and method for improving battery life and accessibility of an outdoor imager, including use of high-power RF directional RF/WiFi for long range image and video transmission with cellphone coverage and use of ultrabright LEDs.

### CROSS REFERENCE TO RELATED APPLICATIONS

This application claims benefit of U.S. Provisional Application 61/587,628 filed 17 Jan. 2012, the contents of which are expressly incorporated by reference in its entirety for all purposes.

### BACKGROUND OF THE INVENTION

The present invention relates generally to portable imaging devices, and more specifically, but not exclusively, to portable outdoor cameras enabling night imaging of nighttime activity of persons and/or animals.

Trail cameras and other nighttime imaging systems are known. Typically they include an incandescent or infrared light source and respond to detected motion to trigger imaging. Other metrics for a trail camera include detection zone, recovery time (time between images), enclosure size, and battery life. Whichever modality or configuration, conventional systems require that a user periodically access/replace the system to retrieve images, replace/repower the energy system, and perform other tasks. Increasingly more feature-rich imaging solutions are desired, including improving battery life and accessibility.

What is needed is a system and method for improving battery life and accessibility of an outdoor imager.

### BRIEF SUMMARY OF THE INVENTION

Disclosed is a system and method for improving battery life and accessibility of an outdoor imager. The following summary of the invention is provided to facilitate an understanding of some of technical features related to low-light flash imagers, and is not intended to be a full description of the present invention. A full appreciation of the various aspects of the invention can be gained by taking the entire specification, claims, drawings, and abstract as a whole. The present invention is applicable to other devices other than trail cameras and to other installations other than imaging animals at feed pile or along a game trail or the like. For example, a security installation for imaging people at a security perimeter and the like.

An outdoor imager, including a housing defining a weather-resistant enclosure for an interior cavity with the enclosure including an imaging aperture; an imager system disposed within the interior cavity, the imager system including an optical system coupled to the imaging aperture and having a sensing system configured to record one or more images during daytime and nighttime from a field of view through the imaging aperture; a motion-detector system generating a motion signal when detecting movement outside the housing; a non-volatile memory receiving and storing the one or more images; an energy storage system disposed in the inner cavity and providing operational power to the imager system; a user-interface coupled to an the housing and configured to receive user input and present messages, a control system responsive to the user input and configured to actuate the imager system when the motion signal is generated; and a transmitter, coupled to the housing and powered by the energy storage system, transmitting the one or more images using a wireless transmission protocol to a remote receiver located more than 2 kilometers from the housing.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a compact trailcam; and

FIG. 2 illustrates a trailcam.

### DETAILED DESCRIPTION OF THE INVENTION

Embodiments of the present invention provide a system and method for improving battery life and accessibility of an outdoor imager. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

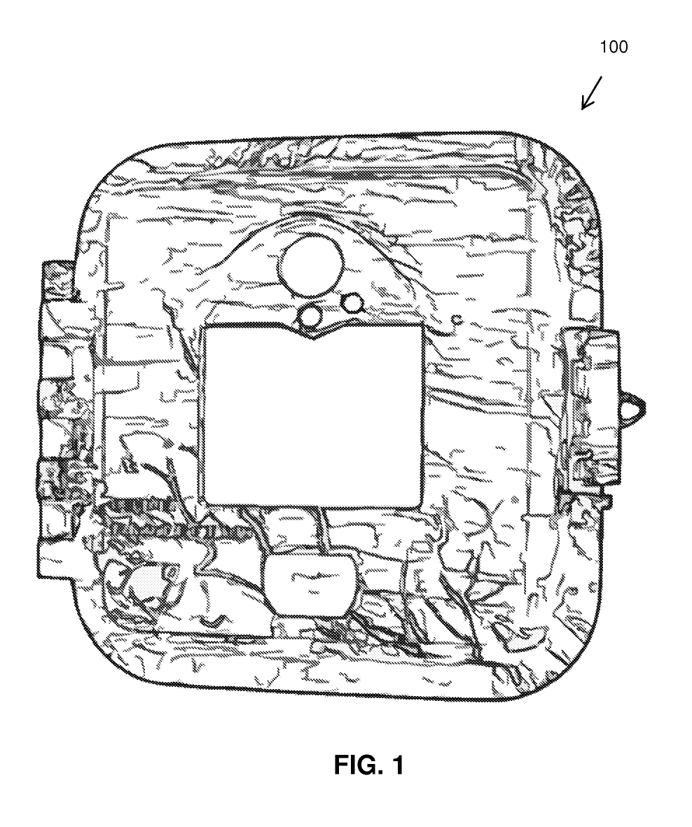

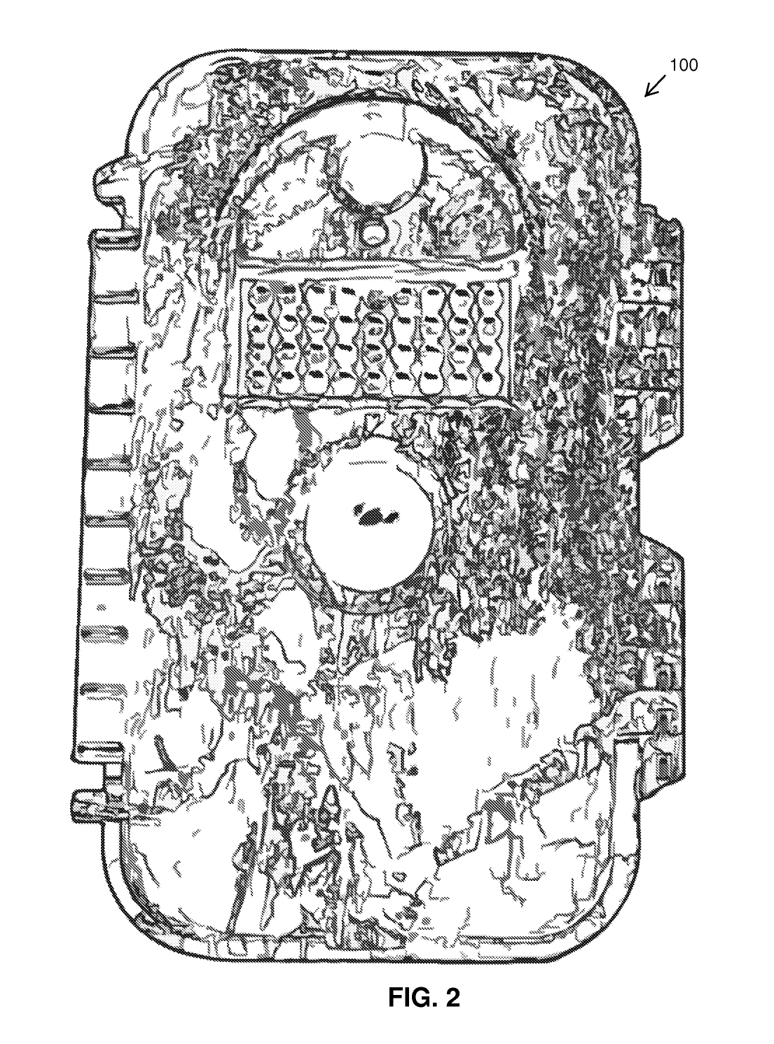

FIG. 1 illustrates a compact trailcam 100 and FIG. 2 illustrates a trailcam 200. Compact trailcam 100 and trailcam 200 both include a hinged housing with desired pattern/design (e.g., camouflage or the like). Compact trailcam 100 and trailcam 200 are designed to be left unattended outside in relatively non-populated areas, to take motion-initiated images during the day or night. Therefore a locking system is incorporated into a secure design for the housing to deter access and unauthorized removal or alteration of components compact trailcam 100/trailcam 200.

Compact trailcam 100 and trailcam 200 include an imager producing 3.2 megapixel stills, VGA Video, 3.5″ LCD with touch screen controls, LED backlit screen, memory/storage options (e.g., USB stick, SD and the like), a passive infrared sensor (PIR) provides high sensitivity thermal motion sensing, 850 nm and 960 nm IR LEDs, selectable; light for video/stills capture is above visual range, auto day/night sensing, camouflage enclosure, is code protected (e.g., password to set/change operation using an I/O interface coupled to a microprocessor-operated controller accessing instructions from a memory or the like), and is all protected within a weather proof enclosure.

Operating details of compact trailcam 100 includes trigger time: 0.5 sec., recovery time: 10 sec., detection range: 80 ft., flash range: 40 ft., memory: USB flash/SD card, approximate size: 6.5″×6.5″×3.25. Trailcam 200 includes trigger time: 0.5 sec., recovery time: 10 sec., detection range: 80 ft., flash range: 30 ft., memory: USB flash/SD card, approx. size: 8.5″h×5.5″ w×2.5″.

Preferred embodiments for both compact trailcam 100 and trailcam 200 include an optional RF wireless module option that provide remote wireless access to images and videos, and permits optional remote configuration to a distance of 3-50 kilometers using directional high output radiofrequency or WiFi adapted for this range or further, with cell phone coverage. Additionally, one or more ultrabright LEDs are used rather than LED arrays to improve battery life and illumination range while lighting night vision shots. The ultrabright LEDs also allow use of a smaller enclosure as compared to systems employing LED arrays.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An outdoor imager, comprising:
a housing defining a weather-resistant enclosure for an interior cavity with said enclosure including an imaging aperture;
an imager system disposed within said interior cavity, said imager system including an optical system coupled to said imaging aperture and having a sensing system configured to record one or more images during daytime and nighttime from a field of view through said imaging aperture;
a motion-detector system generating a motion signal when detecting movement outside said housing;
a non-volatile memory receiving and storing said one or more images;
an energy storage system disposed in said inner cavity and providing operational power to said imager system;
a user-interface coupled to an said housing and configured to receive user input and present messages,
a control system responsive to said user input and configured to actuate said imager system when said motion signal is generated; and
a transmitter, coupled to said housing and powered by said energy storage system, transmitting said one or more images using a wireless transmission protocol to a remote receiver located more than 2 kilometers from said housing.

2. The outdoor imager of claim 1 wherein said motion-detector includes a passive infrared sensor configured to provide thermal motion sensing at a distance of at least 70 feet.

3. The outdoor imager of claim 1 wherein said imager system includes an external illumination system responsive to a low-light condition and to said motion signal to illuminate said field of view at a distance of at least 30 feet sufficient for said imager to capture said one or more images.

4. The outdoor imager of claim 2 wherein said imager system includes an external illumination system responsive to a low-light condition and to said motion signal to illuminate said field of view at a distance of at least 30 feet sufficient for said imager to capture said one or more images.

5. The outdoor imager of claim 1 wherein said user-interface includes an LCD presenting touch screen controls.

6. The outdoor imager of claim 1 wherein said transmitter is configured to transmit directional high output radiofrequency signals to said remote receiver located a distance greater than 25 kilometers from said housing.

7. The outdoor imager of claim 1 further comprising a local receiver, coupled to said control system, coupled to said housing and powered by said energy storage system, receiving remote configuration data using a wireless transmission protocol from a remote transmitter located more than 2 kilometers from said housing.

8. The outdoor imager of claim 7 wherein said remote transmitter is configured to transmit directional high output radiofrequency signals to said local receiver across a distance greater than 25 kilometers separating said local receiver and said remote transmitter.
